(19) United States
(12) Patent Application Publication
(10) Pub. No.: US 2011/0269460 A1
(43) Pub. Date: Nov. 3, 2011

(54) Closed Subscriber Group Cell Identification for Active Mode Mobility

(75) Inventors: Lars Dalsgaard, Oulu (FI); Benoist Pierre Sebire, Tokyo (JP); Jarkko Tuomo Koskela, Oulu (FI); Ivan Ore, Nummela (FI)

(73) Assignee: NOKIA CORPORATION, Espoo (FI)

(21) Appl. No.: 12/681,304

(22) PCT Filed: Sep. 25, 2008
(86) PCT No.: PCT/IB2008/053922

§ 371 Date: Jul. 22, 2010

Related U.S. Application Data
(60) Provisional application No. 60/997,275, filed on Oct. 1, 2007.

(51) Int. Cl. H04W 60/00

(52) U.S. Cl. 455/435.1

(57) ABSTRACT

While camped on a first cell with a first access node, it is determined that a second cell of a second access node is a private cell. From information received from a network it is determined that a criteria is satisfied, and conditional on the criteria being satisfied, a unique identifier for a private network of the private cell is decoded. Exemplary embodiments include a method, apparatus and computer readable medium storing a program. In various specific and non-limiting embodiments: being camped on the first cell comprises being in an active RRC CONNECTED state; the information received is broadcast information, the determining is by comparing received L1 ID to a list of locally stored CSG L1 IDs; the received broadcast information comprises a first portion of a TA ID and the criteria being satisfied comprises the first portion matching an entry of a locally stored whitelist.

### TECHNICAL FIELD

The exemplary and non-limiting embodiments of this invention relate generally to wireless communication systems, methods, devices and computer program products and, more specifically, relate to mobility of UEs moving among, to or from a private network cell such as an E-UTRAN home e-NB.

### BACKGROUND

Following are some acronyms used in this description:
BCH broadcast channel
CSG closed subscriber group
eNB evolved Node B (base station)
E-UTRAN evolved UTRAN (3.9 G or LTE)
GERAN GSM EDGE radio access network
GSM global system for mobile communications
ID identity
LTE long term evolution
MME mobility management entity
NAS non access stratum
OFDM orthogonal frequency division multiple access
P-BCH primary BCH
PLMN public land mobile network
P-SCH primary synchronisation channel
SFN system frame number
S-SCH secondary synchronisation channel
SU-1 scheduling unit 1 (system information)
TA tracking area
UTRAN UMTS terrestrial radio access network (3G)
UE user equipment
WLAN wireless local area network
WCDMA wideband code division multiple access

As known to those skilled in the art, the adjacent cell measurements are the basis for the handover and cell reselection decisions. The user equipment UE (mobile terminal), measures signal quality (such as signal strength, bit error rate BER, bit error probability BEP, or other signal quality parameters in use) from its serving cell and also from adjacent cells and reports these to the network in a measurement report. The UE typically determines which cells are adjacent, and more narrowly which ones to measure, based on neighbor lists which in the prior art are delivered to the UEs on one or more control channels of the wireless system. The neighbor lists contain the necessary data about the adjacent cell so that the UE can find the neighbor cells easily and efficiently with reference to the list stored in its local memory.

In a large network with an extensive number of small cells, the process of determining the right or most appropriate neighbor to include in the neighbor lists that are used to configure the network is a substantial task. E-UTRAN is developing to include more network cells than previous systems, including private networks (a single cell or group of cells) which E-UTRAN terms closed subscriber group CSG network cells with home eNBs (node B's or base stations/access nodes). These are also known more generically as private networks, and are available for traffic (data and/or voice) only to those UEs specifically allowed access (e.g., registered as subscribers or guests) in the private network's subscriber group. Other wireless systems (GERAN, GSM, UTRAN, WCDMA, OFDM) are also proceeding in this general direction incrementally as more functionality is shifted from the radio network controller RNC to the base stations BSs. An individual private network may cover a relatively large geographic area with multiple cells (e.g., a corporate network or a large university campus), or may consist of a single home node B. Below, the term whitelist is used to refer to a list of private (CSG) cells for which a particular UE has access rights.

The closed subscriber group concept has been introduced is being standardized in E-UTRAN in 3GPP TS 36.300; Overall Description; Stage 2 (V8.1.0) (attached as Appendix A to the priority document U.S. Provisional Patent Application Ser. No. 60/997,275, filed Oct. 1, 2007). CSG refers to a group of users which are given the rights to access a CSG cell. In other words, a CSG cell can only be accessed by UEs which belong to the CSG associated to that cell.

The CSG layer refers to the layer formed by the CSG cells, and macro layer refers to the layer formed by the non-CSG cells (i.e. regular cells for which no CSG is defined). A CSG subnet refers to cells with continuous coverage associated to the same CSG.

Mobility of UEs inside the CSG layer and between CSG and macro layers are new cases in 3GPP and may deserve quite different solutions than are typically used for the macro layer alone. Major challenges involving the CSG mobility include the mobility of the access node (femto/home cell) and the high number of access nodes that are expected. These characteristics may lead to the adoption of a different mobility strategy where UE takes more responsibility in the mobility rules while limiting as much as possible the network support.

When looking at the mobility between CSG and non-CSG cells, the following working assumptions are used:
A CSG subnet may contain from one to many cells
Each CSG subnet will have at least one unique CSG identifier (termed herein a CSG TA ID) assigned within the PLMN
Network (NAS) delivers a whitelist of one or more CSG TA's to the UE.
P-BCH indicates whether the cell is CSG or not (alternatively this may be explicitly signaled via P-SCH and/or S-SCH).
The CSG subnet may be co-located on the same frequency layer or may be deployed on a separate frequency layer

The CSG TA ID (tracking area identity of the TA the CSG cell belongs to) is currently assumed to be present in scheduling unit 1 (SU-1) of the broadcast information (broadcast control channel) of each CSG cell, as detailed at 3GPP TS 36.300; Overall Description; Stage 2 (V8.1.0) referenced above. Although SU-1 is known to be scheduled every 80 ms, the exact timing/placement of SU-1 in a target/neighboring cell is not known to a particular UE unless it starts decoding the P-BCH of that neighboring cell (assuming the SFN is included in the P-BCH). The P-BCH is sent every 40 ms or less (down to 10 ms intervals).

This indicates that reading of the neighbor cell's SU-1 for obtaining its TA ID is not a straightforward task—especially if the UE is in the RRC_CONNECTED state and involved in active data transfer.

So, if a UE has a CSG TA whitelist assigned, it will have to read the P-BCH of an identified/adjacent cell in order to read the status of that cell as to whether or not that identified cell is a CSG cell. Then, for each cell identified as a CSG cell, the UE needs to read the CSG TA information from the SU-1. If the CSG neighbor cell CSG TA matches one entry in the CSG TA whitelist, the UE may use the cell as a mobility (e.g., handover) candidate. If the CSG neighbor cell TA does not match an entry in the UE's TA whitelist, the UE may not use the cell as a mobility candidate since those CSG cells not on the UE's whitelist do not allow that UE access to the CSG subnet.

The inventors conclude that this procedure will result in excessive SU-1 reading from neighboring cells, even for UEs which only have one CSG subscription (e.g., home eNBs with one or only a few members).

What is needed is a way to more efficiently enable the UE to identify CSG cell IDs.

### BRIEF DESCRIPTION OF THE DRAWINGS

FIG. 1 is a high level block diagram of various devices used in carrying out various aspects of the invention.

FIG. 2 is a process flow diagram that illustrates a particular embodiment of the invention.

### SUMMARY

In accordance with one exemplary embodiment of the invention is a method that includes, while camped on a first cell with a first access node, determining that a second cell of a second access node is a private cell. The method continues with determining from information received from a network that a criteria is satisfied, and conditional on the criteria being satisfied, decoding a unique identifier for a private network of the private cell.

In accordance with another exemplary embodiment of the invention is a memory embodying a program of machine-readable instructions that when executed by a processor cause actions related to a decoding decision. In this embodiment the actions include, while camped on a first cell with a first access node, determining that a second cell of a second access node is a private cell. Further, the actions include determining from information received from a network that a criteria is satisfied, and conditional on the criteria being satisfied, decoding a unique identifier for a private network of the private cell.

In accordance with yet another exemplary embodiment of the invention is an apparatus that includes a processor and a receiver. The processor is configured to determine, while camped on a first cell with a first access node, that a second cell of a second access node is a private cell. The receiver is configured to receive information from a network. The processor is further configured to determine from received information that a criteria is satisfied, and conditional on the criteria being satisfied, further configured to decode a unique identifier for a private network of the private cell.

In accordance with a further exemplary embodiment of the invention is an apparatus that includes processing means (such as for example a digital processor) and receive means (such as for example a receiver of a transceiver). The processing means is for determining, while the apparatus is camped on a first cell with a first access node, that a second cell of a second access node is a private cell. The receive means is for receiving information from a network, and the processing means is further for determining from received information that a criteria is satisfied, and conditional on the criteria being satisfied, for decoding a unique identifier for a private network of the private cell.

### DETAILED DESCRIPTION

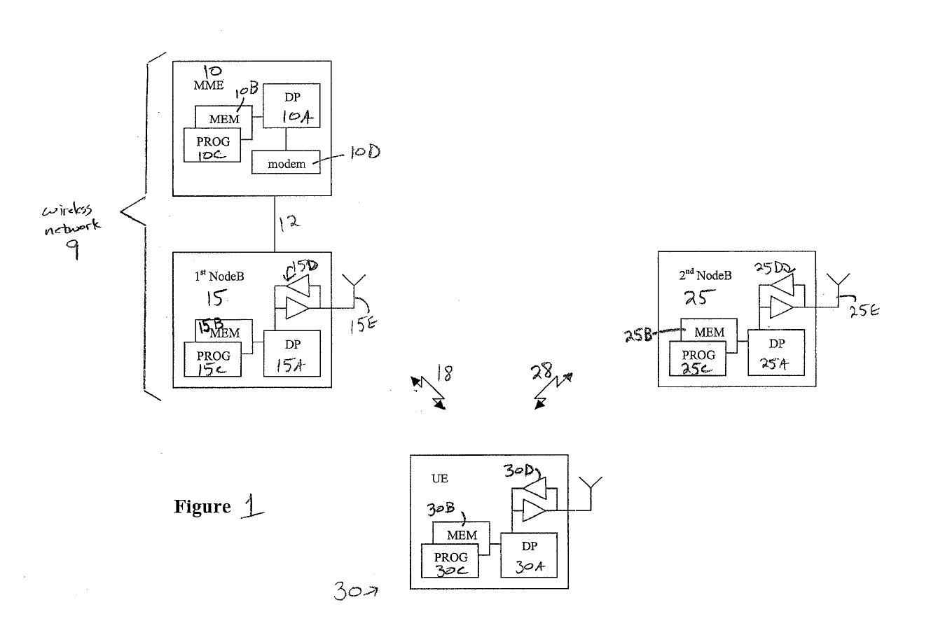

Prior to detailing the particular embodiments of the invention, reference is made first to FIG. 1 for illustrating a simplified block diagram of various electronic devices that are suitable for use in practicing the exemplary embodiments of this invention. In the description of the invention below, the serving cell (which may be CSG or macro) is represented in FIG. 1 as the first node B and the neighbor CSG cell is represented as the second node B. In FIG. 1 a first wireless network 9 which is a public network (e.g., traditional access network that does not grant access based on membership in a CSG) is adapted for communication with a UE 30 via a first Node B 15 over a first wireless link 18, and also a second wireless network (e.g., a CSG subnet) is adapted for communication with the UE 30 via a second (home) Node B 25 over a second wireless link 28. The wireless links 18, 28 are generally active only at different times though this is not a necessary precondition since certain UEs may have multiple transceivers. While the MME 10 is shown as controlling only one Node B 15 in the first network 9, it is understood that it may control multiple macro Node Bs. The term MME represents by example a network element further removed from the UE 30 than the Node B 15, and the MME 10 may be known alternately as a gateway, a radio network controller, or by other terms in different types of networks. The Node B's may be eNBs or generic base stations. Another higher network element may be over the second node B (CSG neighbor cell) for the case where the private network is large. The MME 10 controls the first Node B 15 through a first lub interface 12. The lub interface 12 may be wired or wireless, and relay nodes may also be present between either of the Node Bs and the UE, such as where either network is a mesh network with fixed and/or mobile relay nodes (not shown). The MME 10 is coupled to a core network CN (not shown, such as a mobile switching center MSC or a Serving GPRS Support Node SGSN) through an S-1 interface as known in the art (termed an lub interface in some other systems).

The MME 10 includes a data processor (DP) 10A, a memory (MEM) 10B that stores a program (PROG) 100, and a modem 10D for modulating and demodulating messages sent and received over the various bidirectional interfaces. Similarly, each of the Node Bs 15 & 25 include a DP 15A & 25A and a MEM 15B & 25B that stores a PROG 15C & 25C. The Node B's 15 & 25 each also include a modem for communicating with their respective RNC 10 over the lub 12, but in FIG. 1 is shown only a suitable radiofrequency RF transceiver 15D & 25D for wireless bidirectional communication at a suitable RF using one or more antennas 15E, 25E (one shown for each), such as with the UE 30 over the links 18 & 28. The UE 30 also includes a DP 30A, a MEM 30B for storing a PROG 30C, and a wireless transceiver 30D. At least the PROGs 100 & 20C, and in some embodiments also 15C, 25C and/or 30C, are assumed to include program instructions that, when executed by the associated DP, enable the electronic device to operate in accordance with the exemplary embodiments of this invention, as will be discussed below in greater detail.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

Certain of the exemplary embodiments of this invention may be computer implemented at least in part by computer software executable by the DP 30A of the UE 30 and by the DP 15A of the first node B 15 (as well as the DPs 25A, 10A of the second node B 15 and MME 10 as may be appropriate in different embodiments), or by hardware, or by a combination of software and hardware.

The various embodiments of the UE 30 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 15B, 25B and 30B may be of any type suitable to the local technical environment and may be implemented using any suitable data storage technology, such as semiconductor-based memory devices, magnetic memory devices and systems, optical memory devices and systems, fixed memory and removable memory. The DPs 10A, 15A, 25A and 30A may be of any type suitable to the local technical environment, and may include one or more of general purpose computers, special purpose computers, microprocessors, digital signal processors (DSPs) and processors based on a multi-core processor architecture, as non-limiting examples.

It is anticipated that at least some aspects of this invention are appropriate to be written into a wireless network protocol or standard. Embodiments of the invention can reside wholly in software.

Now are described the exemplary embodiments of the invention with particularity, which as above are directed toward simplifying the effort used by the UE for identifying and reading information from neighboring CSG cells while in the RRC_CONNECTED state (active state), for mobility and possibly other purposes (e.g. self optimising networks).

Six different aspects are detailed to do this, which may be used singly or any combination or subcombination as may be appropriate to the actual network conditions and layout. These are summarized first then described in detail:
1) A portion of the CSG TA ID is reflected in the P-BCH.
2) The UE need not read any information from its neighbor CSG cell if the UE does not have any CSG subscription or is otherwise commanded to do so by the network.
3) System information of a CSG cell will indicate the size of the CSG subnet (to which the cell belongs). This enables the UE to be able to tell whether the CSG subnet is small or large. Alternatively this indication of CSG subnet size could be sent via NAS signaling from the core network (e.g., via the public network 9), but from whatever source this information is sent to the UE.
4) The macro eNBs (of the public network 9) broadcast in the system information a portion of the CSG TA ID (those CSG IDs of CSG cells existing under the macro eNB).
5) The UE only needs to read SU-1 of a neighboring cell under certain specific circumstances.
6) Further to 4) and 5), a portion of the CSG TA ID could be reflected in the synchronization channel SCH, which is also broadcast from the macro eNBs.

The above aspects are detailed seriatim with particularity. Respecting aspect 1) above, it is a common understanding that a CSG network will be assigned at least one unique TA ID, termed herein for precision the CSG TA. For completeness but not as a limiting aspect of this invention, it is also the common understanding that this CSG TA will be different from the normal TA (of a non-CSG cell) in the sense that it will be larger. A part, but not the whole, of the CSG TA is broadcast on the P-BCH. Term this a SHORT CSG TA. Broadcasting only a part of the CSG TA (e.g. the last 6 bits) on the P-BCH would remove or significantly reduce the need for the active mode UE to read the neighboring CSG cell SU-1 for obtaining the (full) CSG TA. The UE will use the SHORT CSG TA as a pre-identifier of the CSG TA. It is noted that since the portion of the CSG TA does not uniquely identify the CSG network/subnetwork (which in certain instances may be only one cell), some other identification number can be used other than the CSG TA, but a portion of the CSG TA is an uncomplicated way to explain the concept of an abbreviated identifier that is only partially but not uniquely identifies the CSG subnet and a ready implementation of it. Using a portion of the CSG TA (or other abbreviated identifier) has the benefit of reducing signaling overhead, in that the full CSG TA need not be made available in system information; the full CGS TA can be split, so that the SHORT CSG TA portion is sent in the P-BCH and the remainder of the full CSG TA is sent in the SU-1. In this embodiment, neither identifier uniquely identifies the CSG subnet, but together the SHORT CSG TA on the P-BCH and the remainder on SU-1 system information make up the full CSG TA that uniquely identifies the CSG subnet. In an alternative embodiment, a portion of the CSG TA is broadcast in the P-BCH, but still the full CSG TA is sent in SU-1 (though perhaps in two different portions). In this alternative embodiment, since the full CSG TA is in the SU-1 information, the abbreviated identifier sent on the P-BCH may or may not be a portion of that full CSG TA since the two are not combined as in the first embodiment noted above.

Additionally, the abbreviated identity (e.g., the SHORT CSG TA) does not need to be necessarily sent in the P-BCH, but the repetition rate of sending the SHORT CSG TA may be made much higher than the repetition rate on the SU-1 (80 ms is the current RAN2 assumption for the SU-1 repetition rate). Therefore, the SHORT CSG TA can be sent separately coded in a different or the same subframe(s) as the P-BCH.

Respecting aspect 2) above, if the neighbor cell is a CSG cell and the UE has no CSG subscription or any (valid) whitelist, the UE need not read any further information from this particular CSG neighbor. A valid whitelist could mean that the UE has received a whitelist from the network but the network has not indicated that the UE is in an area in which the whitelist is valid. Note that the above are alternative; in one case the UE does not decode the CSG TA (short or long) of a neighbour CSG cell if it is a not a member of any CSG, and in another case the UE does not decode the CSG TA (short or long) of a neighbor CSG cell if it does not have a currently valid whitelist, even though it may be a member of a CSG at some location remote to where the UE is currently camped.

Respecting aspect 3) above, the indication of the size of the current CSG network can be realized simply by introducing a one bit indicator: for example ‘0’ indicates a small CSG network while ‘1’ indicates a large CSG network (or vice versa). More control bits would be used for better granularity, but the inventors deem that one bit would be sufficient for the large majority of cases. This indicator can be sent from the core network to the UE as part of its CSG subscription information. The motivation for this indication is to differentiate two different mobility mechanisms according to the size of the network. For large CSG networks, a network supported mobility suits best (e.g., the neighbor cell list definition is provided by the network operator). For small networks, such as home cells/home eNBs, applying network planning for hundreds of home cells is not seen to be feasible in practice and so mobility procedures are better designed to rely on UE assistance.

Respecting aspect 4) above, as part of the neighbor cell list information, the macro eNB broadcasts a list of short CSG TA IDs from existing CSG cells in an embodiment of this aspect of the invention. This may be a bit higher in signaling overhead for the case where there are a very high number of private cells within a macro-cell of the public network (as is expected while LTE develops private cells further), but is certainly a viable and workable option at least until the list becomes overly burdensome.

Respecting aspect 5) above, limiting the requirements for the UE to read neighbor cell SU-1 is done simply by specifying the UE behaviour in situations where the cell identification (or P-BCH) or some other information available to the UE indicates that the cell is a CSG cell. As an example, the UE will be required to read the neighbour cell SU-1 only if any of the following circumstances are met:
If the UE belongs to at least one CSG (i.e. it has access to at least one CSG subnet);
If the neighboring cell is a CSG cell (as identified by the P-BCH or SCH or neighbour cell list);
If the neighboring cell is a CSG cell and the received signal quality goes above a given threshold (e.g. it becomes the best candidate for mobility);
If the network has indicated to the UE that at least one of the CSG subnet to which it has access is present in the UE's vicinity;
If the neighboring cell's lower layer identity matches the CSG cell information;
If the UE has a CSG TA in its whitelist that matches the CSG TA in the P-BCH of the neighbour cell; and
if the network has indicated to the UE about any CSG identities, e.g. L1 Cell ID (synchronization channel codes). But, the UE may omit reading SU-1 for those cells whose L1 Cell ID has not been indicated to belong to the CSGs to which the UE is registered.

Respecting aspect 6) above, a portion (but not the full) CSG TA can be broadcast on one of the SCHs, along with the indication whether the cell is a CSG cell or not (if that indication is not sent on the P-BCH, for example). The portion can be the remainder of the full CSG TA other than the short CSG TA that is sent on the P-BCH. Ideally the short CSG TA would be unique for CSG cells within the macro cell and so the remainder on the SCH would be common to all of the CSG cells within that macro cell, and a single remainder is valid for all of those CSG cells. The UEs then find the full CSG TA by combining the remainder received CGS TA over the macro cell's SCH and the unique portion of it received on the P-BCH. Alternatively, the portion can be broadcast on the SCH rather than the P-BCH and the remainder found from the SU-1 as detailed above.

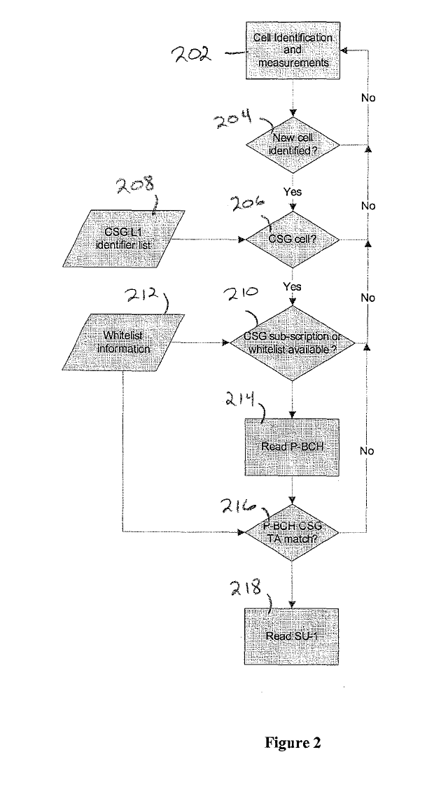

Certain of the above aspects are shown in a single cohesive embodiment at FIG. 2. At block 202 the UE identifies a non-CSG cell (or its current CSG cell) and sends a measurement report with its identifier as normal. Then at block 204 the UE begins to receive a new cell, and determines at block 206 if that new cell is a CSG cell by comparing its layer 1 ID with a CSG Layer 1 ID list stored in the UE's local memory. If the new cell is not a CSG cell then identification and measurement reports are sent as normal (e.g., as is currently understood for E-UTRAN). If instead the layer 1 ID of the new cell matches a layer 1 CSG ID (L1 TA) in the list of block 208, then at block 210 the UE checks the CSG ID against its whitelist stored at block 212 in its local memory to see if it has access to any cell of that layer 1 CSG ID (or checks to see if the network has indicated that the UE even has a valid whitelist for the area in which the UE is camped according to the alternative detailed above). If no then the UE need not report this CSG cell and does not use it as a handover/mobility candidate. If yes then in an embodiment the process continues at block 214 where the UE reads the P-BCH to obtain the short CSG TA or other short identifier, and at block 216 compares that short CSG TA with its whitelist (of short CSG TAs sent by the non-CSG macro cell under which the CSG cell operates such as that at block 202) to find a match. If there is no match then the UE disregards that new CSG cell and does not add it to its list of handover candidates. If there is a match again at block 216, or if the short CSG TA option of block 216 is not used (block 214 may be also be skipped if the full CSG TA is available on the SU-1), then the UE reads the SU-1 information to obtain the remainder of the new CSG cell's CSG TA (or to obtain the full CSG TA if the P-BCH at block 214 was an identifier other than the short CSG TA or even if it was in some embodiments). Once the full CSG TA is obtained after block 218, then the UE can add the new CSG cell to its handover candidate list and may eventually report the cell to network in a measurement report. The network may then handover the UE to that new CSG cell, such as by a network controlled UE-assisted handover to the CSG cell.

So in view of the above, the following advantages may be realized by embodiments of this invention. In general the UE's need for reading neighbor cell information is greatly reduced as compared to the prior art, as is the amount of neighbor SU-1 readings the UE must perform. Also reduced is the number of possible interrupts in data transmission due to neighboring SU-1 readings, as well as the UE power consumption. If only 1 Layer 1 PHY cell ID (SCH-ID) is reserved, the L1 CSG TA would be the primary UE filter (at block 206) for lowering the reporting CSG cells. Embodiments of the invention also reduce the UE memory requirements for memorizing CSG network cell and CSG location information (LA).

The above embodiments can be made mandatory for the UEs in a wireless specification so that different UE manufacturers/software programmers can have their handsets operate consistently within the CSG network.

Based on the foregoing it should be apparent that the exemplary embodiments of this invention provide a method, apparatus and computer program product(s) for a UE to camp on a first cell, to identify a neighbor cell as a private cell, and then to determine whether the private neighbor cell is a candidate for UE mobility by any one or combination of the following: comparing a layer 1 ID of the private neighbor cell to a layer 1 ID list provided by a network; determining whether the private neighbor cell is on a whitelist for the UE; determining if the UE has a valid whitelist; and determining whether a short identifier sent by the private neighbor cell on its P-BCH matches any of the UE's whitelist identifiers. In an embodiment, the private cell broadcasts an indication of whether or not it is a private cell. Once the UE determines that the private cell is a candidate for mobility, then the UE can add the private cell to its handover candidate list, and a tangible result outside the UE itself is handing over to the private neighbor cell (such as via a UE-initiated handover).

Various of the above embodiments may be described as, while camped on a first cell with a first access node, determining that a second cell of a second access node is a private cell, then determining from information received from a network that a criteria is satisfied, and conditional on the criteria being satisfied, decoding a unique identifier for a private network of the private cell.

In one embodiment, camped on the first cell is evidenced by being in an active RRC CONNECTED state with the first access node.

In the following embodiments, the information received from the network is broadcast information. For example, determining that the second cell is private cell can be done by receiving a layer 1 identifier for the private network and comparing the received layer 1 identifier to a list of closed subscriber group layer 1 identifiers stored in a local memory of a user equipment executing the method of claim 1. For the embodiment where the received broadcast information is a first portion of a tracking area identifier for the private network, the criteria being satisfied is that the first portion of the tracking area identifier matches an entry of a whitelist stored in a local memory, and decoding the unique identifier is satisfied by decoding a remainder second portion of the tracking area identifier from system information of the second access node, in which the unique identifier is made up of both the first portion and the second portion of the tracking area identifier. For the embodiment where the received broadcast information is an abbreviated identifier for the private network, the criteria being satisfied is the abbreviated identifier matching an entry of a list stored in a local memory, and decoding the unique identifier is satisfied by decoding a full tracking area identifier from system information of the second access node. Determining that the second cell is a private cell may be done by matching an abbreviated identifier received from the second access node to an entry of a first list received from the second access node that includes first portions of tracking area identifiers for closed subscriber groups In this particular embodiment the received broadcast information is the abbreviated identifier, the criteria being satisfied is the matched entry from the first list matching an entry of a whitelist stored in a local memory, and decoding the unique identifier may be completed by decoding a full tracking area identifier from system information of the second access node; or by decoding a second portion of a tracking area identifier from system information of the second access node (in which the unique identifier is made up of both the matching abbreviated identifier and the second portion of the tracking area identifier).

In another embodiment, the information received is a whitelist and the criteria is an indication from the network which sent the whitelist that the whitelist is valid for the area of the private cell, and the unique identifier is then a closed subscriber group tracking area for the private network.

In some embodiments, the decoded unique identifier is compared against a locally stored whitelist, and if there is a match between the decoded unique identifier and an entry of the locally stored whitelist, then the UE initiates a handover from the first access node to the second access node by a user equipment executing the method.

Based on the foregoing it should be apparent that the exemplary embodiments of this invention provide a method, apparatus and computer program product(s) for a node B to do any or all of the following: broadcast an indicator of whether or not the node B is a private cell, and if private then to broadcast an indication of a relative size of the private network of which it is a part; broadcast on a P-BCH an identifier shorter than a CSG TA ID (e.g., the short CSG TA), and send to a UE a list of short CSG TAs (or other short identifiers) in its area.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block and signaling diagrams, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
while camped on a first cell with a first access node, determining that a second cell of a second access node is a private cell;
determining from information received from a network that a criteria is satisfied; and
conditional on the criteria being satisfied, decoding a unique identifier for a private network of the private cell.

2. The method of claim 1, wherein camped on the first cell comprises being in an active RRC CONNECTED state with the first access node, and wherein the method is executed by a user equipment that is an RRC CONNECTED state with the first access node.

3-24. (canceled)

25. The method of claim 2, wherein the information received from the network comprises broadcast information.

26. The method of claim 25, wherein determining that the second cell is a private cell comprises receiving a layer 1 identifier for the private network and comparing the received layer 1 identifier to a list of closed subscriber group layer 1 identifiers stored in a local memory of a user equipment.

27. The method of claim 25,
wherein the received broadcast information comprises a first portion of a tracking area identifier for the private network,
wherein the criteria being satisfied comprises the first portion of the tracking area identifier matching an entry of a whitelist stored in a local memory,
and wherein decoding the unique identifier comprises decoding a remainder second portion of the tracking area identifier from system information of the second access node, in which the unique identifier comprises both the first portion and the second portion of the tracking area identifier.

28. The method of claim 25,
wherein the received broadcast information comprises an abbreviated identifier for the private network,
wherein the criteria being satisfied comprises the abbreviated identifier matching an entry of a list stored in a local memory,
and wherein decoding the unique identifier comprises decoding a full tracking area identifier from system information of the second access node.

29. The method of claim 25,
wherein determining that the second cell is a private cell comprises matching an abbreviated identifier received from the second access node to an entry of a first list received from the second access node that comprises first portions of tracking area identifiers for closed subscriber groups,
wherein the received broadcast information comprises the abbreviated identifier,
wherein the criteria being satisfied comprises the matching entry of the first list matching an entry of a whitelist stored in a local memory,
and wherein decoding the unique identifier comprises decoding one of: a full tracking area identifier from system information of the second access node; or a second portion of a tracking area identifier from system information of the second access node in which the unique identifier comprises both the matching abbreviated identifier and the second portion of the tracking area identifier.

30. The method of claim 25, wherein the information received comprises a whitelist and the criteria comprises an indication from the network which sent the whitelist that the whitelist is valid for the area of the private cell, and wherein the unique identifier comprises a closed subscriber group tracking area for the private network.

31. The method of claim 1, wherein decoding the unique identifier comprises decoding system information broadcast by the second access node, the method further comprising, after decoding:
comparing the decoded unique identifier against a locally stored whitelist.

32. The method of claim 31, further comprising, if there is a match between the decoded unique identifier and an entry of the locally stored whitelist, initiating a handover from the first access node to the second access node by a user equipment executing the method.

33. A memory embodying a program of machine-readable instructions that when executed by a processor cause actions related to a decoding decision, the actions comprising:
while camped on a first cell with a first access node, determining that a second cell of a second access node is a private cell;
determining from information received from a network that a criteria is satisfied; and
conditional on the criteria being satisfied, decoding a unique identifier for a private network of the private cell.

34. The memory of claim 33, wherein decoding the unique identifier comprises decoding system information broadcast by the second access node, the actions further comprising, after decoding:
comparing the decoded unique identifier against a locally stored whitelist, and conditional on a match between the decoded unique identifier and an entry of the locally stored whitelist, initiating a handover from the first access node to the second access node.

35. An apparatus comprising:
a processor configured to determine, while camped on a first cell with a first access node, that a second cell of a second access node is a private cell;
a receiver configured to receive information from a network;
wherein the processor is further configured to determine from received information that a criteria is satisfied, and conditional on the criteria being satisfied, further configured to decode a unique identifier for a private network of the private cell.

36. The apparatus of claim 35, further comprising a transmitter, and wherein the apparatus is camped on the first cell when the transmitter and receiver place the apparatus in an active RRC CONNECTED state with the first access node.

37. The apparatus of claim 36, wherein the information the receiver is configured to receive comprises broadcast information.

38. The apparatus of claim 36, further comprising a memory storing a list of closed subscriber group layer 1 identifiers;
wherein the receiver is further configured to receive a layer 1 identifier for the private network; and
the processor is configured to determine that the second cell is a private cell by comparing the received layer 1 identifier to the stored list of closed subscriber group layer 1 identifiers.

39. The apparatus of claim 37,
wherein broadcast information comprises a first portion of a tracking area identifier for the private network,
wherein the processor is configured to determine that the criteria is satisfied by matching the first portion of the tracking area identifier to an entry of a whitelist stored in a memory of the apparatus,
and the processor is configured to decode the unique identifier by decoding a remainder second portion of the tracking area identifier from system information of the second access node that is received by the receiver, in which the unique identifier comprises both the first portion and the second portion of the tracking area identifier.

40. The apparatus of claim 37,
wherein the received broadcast information comprises an abbreviated identifier for the private network,
wherein the processor is configured to determine that the criteria is satisfied by matching the abbreviated identifier to an entry of a list stored in a local memory,
and the processor is configured to decode the unique identifier by decoding a full tracking area identifier from system information of the second access node that is received by the receiver.

41. The apparatus of claim 36,
wherein the receiver is further configured to receive system information from the second access node and is further configured to receive an abbreviated identifier and a first list from the second access node, the first list comprising first portions of tracking area identifiers for closed subscriber groups;
wherein the processor is configured to determine that the second cell is a private cell by matching the received abbreviated identifier to an entry of the received first list,
wherein the received broadcast information comprises the abbreviated identifier,
wherein the processor is configured to determine that the criteria is satisfied by matching an entry of the first list to an entry of a whitelist stored in a memory of the apparatus,
and wherein the processor is configured to decode the unique identifier by decoding one of: a full tracking area identifier from the received system information; or a second portion of a tracking area identifier from the received system information in which the unique identifier comprises both the matching abbreviated identifier and the second portion of the tracking area identifier.

42. The apparatus of claim 36, wherein the information received comprises a whitelist and the processor is configured to determine that the criteria is satisfied by determining that the whitelist is valid for the area of the private cell, and wherein the unique identifier comprises a closed subscriber group tracking area for the private network.

43. The apparatus of claim 36, wherein the receiver is further configured to receive system information from the second access node;
and wherein the processor is configured to decode the unique identifier by decoding the system information;
and the processor is further configured to compare the decoded unique identifier against a whitelist stored in a memory of the apparatus.

44. The apparatus of claim 43, wherein the processor is further configured, conditional on there being a match between the decoded unique identifier and an entry of the whitelist, to initiate via a transmitter of the apparatus a handover of the apparatus from the first access node to the second access node.
